(19) United States
(12) Patent Application Publication
(10) Pub. No.: US 2016/0203218 A1
(43) Pub. Date: Jul. 14, 2016

(54) APPARATUS AND METHOD FOR DEVELOPING COMPLEX QUERIES OF SOCIAL MEDIA SOURCES

(71) Applicant: Xerox Corporation, Norwalk, CT (US)

(72) Inventors: David R. Vandervort, Walworth, NY (US); Saurabh Singh Kataria, Rochester, NY (US); Veerasundaravel Thirugnanasundaram, Webster, NY (US)

(21) Appl. No.: 14/593,593

(22) Filed: Jan. 9, 2015

(51) Int. Cl. G06F 17/30

(52) U.S. Cl. CPC G06F 17/30864; G06F 17/30392

(57) ABSTRACT

An apparatus, method and non-transitory computer readable medium for developing a query on a social media service are disclosed. For example, the apparatus includes a processor and a computer readable medium storing a plurality of instructions, which when executed by the processor, cause the processor to perform operations for developing the query on the social media service. The operations include receiving a keyword, providing an option to select a sentiment and an option to include a time frame, finding a plurality of related keywords based on the keyword, the sentiment that is selected and the time frame that is selected using one or more external databases, generating the query using the keyword and all of the plurality of related keywords and the time frame that is selected and applying the query to the social media service.

The present disclosure relates developing queries and, more particularly, to an apparatus and method for developing complex queries of social media services.

### BACKGROUND

Social media websites generate an enormous amount of data about an ever changing array of topics. As a result, there are many tools and techniques for mining these streams for items of interest to companies, agencies and researchers. However, the single most used tool is the keyword search and these searches can be very complex and difficult to develop.

For example, when searching for a particular topic, currently used keyword searches may only search for an identical match of the keyword. Many of the search results may be unrelated or out of context. In addition, manually attempting to include all related keywords and terms can be a time consuming process that may still omit keywords. Furthermore, even if all of the keywords and related keywords are manually entered, the search results may still include matches that are unrelated or out of context.

### SUMMARY

According to aspects illustrated herein, there are provided an apparatus, a method and a non-transitory computer readable medium for developing a query on a social media service. One disclosed feature of the embodiments is an apparatus that comprises a processor and a computer readable medium storing a plurality of instructions, which when executed by the processor, cause the processor to perform operations for developing the query on the social media service. The operations comprise receiving a keyword, providing an option to select a sentiment and an option to include a time frame, finding a plurality of related keywords based on the keyword, the sentiment that is selected and the time frame that is selected using one or more external databases, generating the query using the keyword and all of the plurality of related keywords and the time frame that is selected and applying the query to the social media service.

Another disclosed feature of the embodiments is a method for developing a query on a social media service comprising receiving a keyword, providing an option to select a sentiment and an option to include a time frame, finding a plurality of related keywords based on the keyword, the sentiment that is selected and the time frame that is selected using one or more external databases, generating the query using the keyword and all of the plurality of related keywords and the time frame that is selected and applying the query to the social media service.

Another disclosed feature of the embodiments is a non-transitory computer-readable medium having stored thereon a plurality of instructions, the plurality of instructions including instructions, which when executed by a processor, cause the processor to perform operations comprising receiving a keyword, providing an option to select a sentiment and an option to include a time frame, finding a plurality of related keywords based on the keyword, the sentiment that is selected and the time frame that is selected using one or more external databases, generating the query using the keyword and all of the plurality of related keywords and the time frame that is selected and applying the query to the social media service.

### BRIEF DESCRIPTION OF THE DRAWINGS

The teaching of the present disclosure can be readily understood by considering the following detailed description in conjunction with the accompanying drawings, in which:

FIG. 1 illustrates one embodiment of a block diagram of a system of the present disclosure;

FIG. 2 illustrates one embodiment of an interface of the present disclosure;

FIG. 3 illustrates a flowchart of one embodiment of a method for developing a query on a social media service; and

FIG. 4 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for developing a query on a social media service. As discussed above, social media websites generate an enormous amount of data about an ever changing array of topics. As a result, there are many tools and techniques for mining these streams for items of interest to companies, agencies and researchers. However, the single most used tool is the keyword search and these searches can be very complex and difficult to develop.

However, currently used keyword searches may perform a keyword search irrespective of a domain. As a result, many of the search results may be unrelated or out of context. In addition, manually attempting to include all related keywords and terms can be a time consuming process that may still omit keywords. Furthermore, even if all of the keywords and related keywords are manually entered, the search results may still include matches that are unrelated or out of context.

Embodiments of the present disclosure provide a novel method for developing a query on a social media service. The embodiments of the present disclosure improve functioning of a computer to automatically develop a complex query based on a single keyword using external third party databases (e.g., online dictionaries, online thesauruses, and the like). In addition, the complex query may be developed within a specific context that is defined by a sentiment and a time frame. In one embodiment, the functioning of the computer may also be configured to be specific for a particular domain (e.g., transportation, health care, and the like). As a result, the query may search for keywords in the complex query that are related to the particular domain.

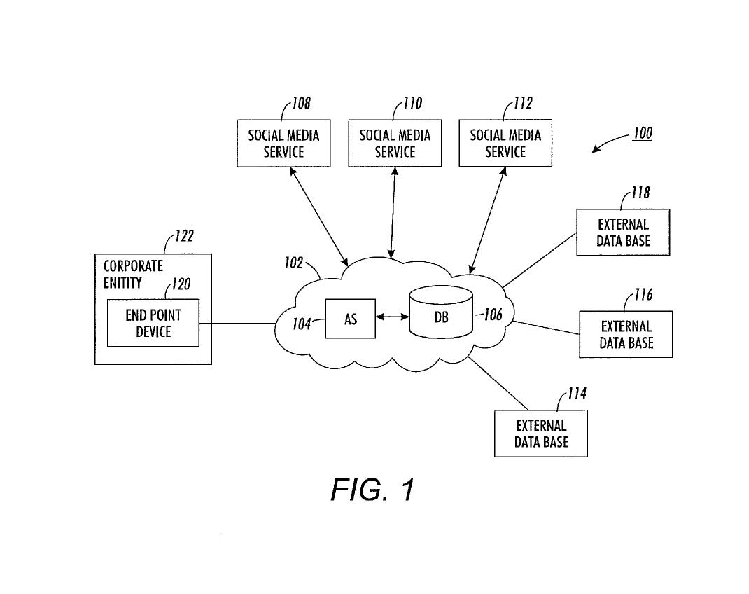

FIG. 1 illustrates an example system 100 of the present disclosure. In one embodiment, the system 100 includes a communications network 102, an application server (AS) 104 and a database (DB) 106. In one embodiment, the communications network 102 may be any type of communications network including, for example, an Internet Protocol (IP) network, a cellular network, a broadband network, and the like.

In one embodiment, one or more social media services 108, 110 and 112 may be in communication with the communication network 102. For example, the one or more social media services 108, 110 and 112 may be social media services that provide short messages by subscribers of the social media services such as Facebook®, Twitter®, Linkedin®, and the like.

In one embodiment, one or more external databases (DB) 114, 116 and 118 may be in communication with the communication network 102. In one embodiment, the external DBs 114, 116 and 118 may be third party language websites (e.g., online dictionaries, online thesauruses, online topic databases, websites such as Wordnik.com®, and the like).

In one embodiment, the system 100 may include a corporate entity 122 having an endpoint device 120 that is in communication with the communication network 102. In one embodiment, the corporate entity 122 may be a subscriber for query services from a service provider of the query services. For example, the corporate entity 122 may be in a particular industry and would like to search for relevant data based on posts of individuals on the social media services 108, 110 and 112. For example, the corporate entity 122 may be looking to target particular individuals based on the messages posted on one or more of the social media services 108, 110 and 112. The corporate entity 122, or an employee of the corporate entity 122, may interface with the AS 104 via the endpoint device 120 to generate the complex query, as discussed in further detail below. In one embodiment, the social media services 108, 110 and 113, the external DBs 114, 116 and 118 and the endpoint device 120 may be in communication with the communication network 102 via either a wired or wireless connection.

It should be noted that although three social media services 108, 110 and 112 are illustrated in FIG. 1, any number of social media services may be deployed. It should be noted that although three external DBs 114, 116 and 118 are illustrated in FIG. 1, any number of external DBs may be deployed. It should be noted that although a single corporate entity 122 and a single endpoint device 120 are illustrated in FIG. 1, any number of corporate entities and endpoint devices may be deployed.

It should be noted that FIG. 1 is a block diagram that has been simplified. The system 100 may include other network elements and access networks that are not shown. For example, the communication network 102 may include other network elements such as a firewall, border elements, gateways, and the like. The communication network 102 may also have additional access networks between the social media services 108, 110 and 112, the external DBs 114, 116 and 118 and the endpoint device 120, such as for example, a cellular access network, a broadband access network, and the like.

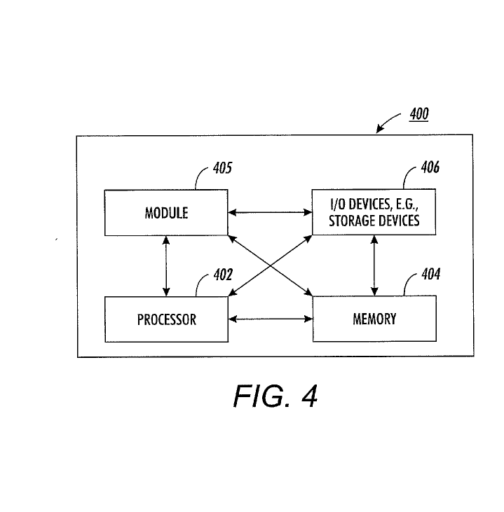

In one embodiment, the AS 104 and the DB 106 may be managed and operated by a service provider of a complex querying service. For example, the AS 104 may deployed as a computer illustrated in FIG. 4 and described below and configured to perform the functions described herein under the control of the service provider. In one embodiment, the DB 106 may store information, such as for example, data and short messages generated by the social media services 108, 110 and 112, complex queries generated by the corporate entity 122, locally stored thesauruses, dictionaries, topic databases, and the like.

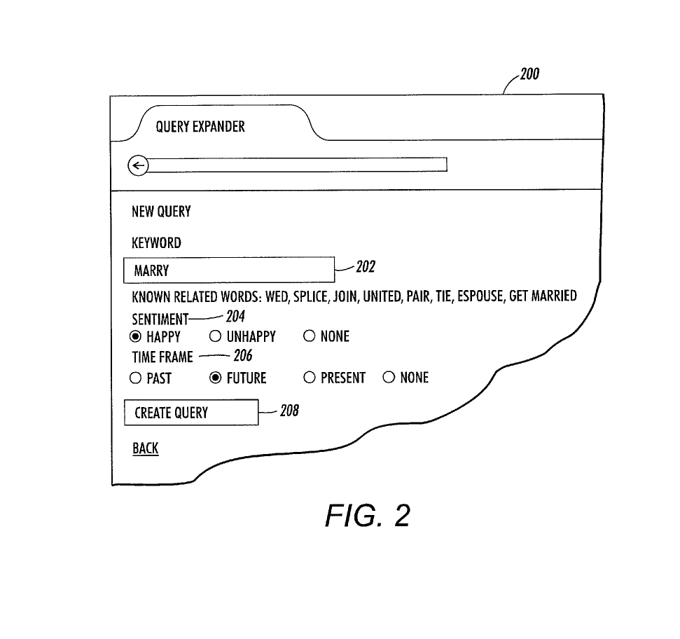

As noted above, the corporate entity 122 may be a subscriber of the complex querying service provided by the service provider of the AS 104 and the DB 106 that generates and applies the complex queries. For example, a user within the corporate entity 122 may wish to generate a complex query for a particular keyword. In one embodiment, the user may interface with the AS 104 via a website or graphical user interface (GUI) 200 illustrated in FIG. 2.

FIG. 2 illustrates one example of a GUI 200 that may be used to generate a complex query of the present disclosure. In one embodiment, the GUI 200 may be a presented as a webpage in a web browser of the endpoint device 120. In one embodiment, the user may enter a keyword in a keyword field 202. In one embodiment, once the keyword is entered one or more related keywords may be displayed below.

In one embodiment, the keyword may be considered to be a main concept of the query and may indicate such things as a user's intent (e.g., to move to another part of the country, to purchase a new car, and the like) or a significant life event (e.g., a graduation, a marriage, and the like). Notably, these keywords are loaded with meaning and can be referred to and discussed in different ways to make simple keyword-based searches inadequate. For example, simple terms such as “married” may find many false positives (e.g., “married to my job”) and overlook the true targets of the query (e.g., “looking forward to getting married next week!”).

In one embodiment, after the keyword is entered and before the final complex query is generated, the AS 104 may look up derivative and related keywords in the DB 106 locally. For example, as more keywords are entered and queries are generated, the results of finding related keywords from previously generated complex queries may be stored in the DB 106.

However, if no related keywords are found for the keyword that is entered, the AS 104 may look up derivative and related keywords, in one or more of the external DBs 114, 116 or 118. For example, a website such as Wordnik.com® that can look up homonyms, antonyms, rhymes and more. Or an online dictionary or thesaurus may be used to look up synonyms of the keyword. Notably, a user may enter a single keyword in the keyword field 202, but the system 100 may automatically expand the query with one or more related keywords.

In one embodiment, the GUI 200 may also provide options for a user to select a sentiment 204 and/or a time frame 206. In one embodiment, the sentiment 204 may include for example, happy, unhappy or none. It should be noted that similar sentiment terms may also be used (e.g., satisfied and unsatisfied, positive and negative, and the like). In one embodiment, the sentiment may be used to capture the emotional import of certain keywords. For example, getting married or starting a new job may be generally things to be happy about. Other things such as chemotherapy or being laid off may be generally things to be unhappy about. The insertion of the sentiment 204 may help remove false positives and give more meaningful results to the query.

In one embodiment, if the sentiment 204 of happy is selected, the AS 104 may automatically look for one or more related sentiment keywords that are associated with a happy sentiment. For example, the AS 104 may look up the related sentiment keywords in the DB 106 locally or one or more of the external DBs 114, 116 and 118 if no related sentiment keywords for the happy sentiment are found in the DB 106 locally. For example, if the keyword is marry and the sentiment 204 of happy is selected, the related sentiment keywords may include words, phrases, emoticons or text such as, excited, looking forward to it, can't wait, great, amazing, [symbol] , <3, and the like. Thus, the generated complex query may include the keyword of “marry”, one or more of the related keywords and the related sentiment keywords. Similarly, if the sentiment 204 of unhappy is selected, the related sentiment keywords may include words such as, dread, nervous, not sure, what did I do, terrible, scared, [symbol] , and the like.

Although life may not be a neutral event, some queries may be run first to see the results before using sentiment to narrow the scope of the query. As a result, an option of none or no sentiment may be a selection for the sentiment 204.

In one embodiment, the time frame 206 may include for example, past, future, present and none. The time frame 206 may be important for certain queries. For example, in a marketing campaign targeting newlyweds, those who have been married for a long time probably should not be included in the results. Thus, a simple query on marriage would provide results that include all married couples, regardless of how long they have been married.

However, by including a sentiment 204 of happy and a time frame 206 of future to the keyword 202, a complex query may be generated that only searches for those couples that are going to get married in the future. For example, without the sentiment, messages about getting divorced (an unhappy event) in the future would be a false positive (e.g., “I won't be married for long”). Alternatively, without the time frame, happy messages about marriage (no specified time frame) may also lead to false positives (e.g., “We have been happily married for 25 years!”). Thus, by including both the sentiment 204 and the time frame 206 to the keyword 202, the complex query may find more accurate search results (e.g., “I can't wait to get married tomorrow!” or “I'm so excited to tie the knot next week!”).

In one embodiment, similar to the related sentiment keywords, the AS 104 may search for related time frame keywords locally in the DB 106 or in one or more of the external DBs 114, 116 and 118. For example, the related time frame keywords for a time frame 206 of past may include, for example, did, yesterday, was, ago, past, and the like. For example, the related time frame keywords for a time frame 206 of present may include, for example, now, today, happening, occurring, ongoing, live, and the like. For example, the related time frame keywords for a time frame 206 of future may include, for example, will be, going to, will happen, tomorrow, and the like.

The time frame 206 may also include a level of urgency. For example, a hotel chain may not be interested in potential newlyweds getting married very soon (e.g., tomorrow). The assumption may be that the couple may have already booked the hotel months ago. Rather, they may be searching for happy sentiment 204 and a future time frame 206 that may be occurring later in the future (e.g., “I just got engaged, can't believe I'm going to get married!”).

In one embodiment, the GUI 200 may also include a create query button 208. For example, once the keyword is entered in the keyword field 202, a sentiment 204 is selected and the time frame 206 is selected, the user may select the create query button 208 to automatically generate the complex query.

In one embodiment, the system 100 may be configured to be for a specific domain that may also provide additional context for accurate results of the generated complex query. For example, the corporate entity 122 may be part of a food service industry. Thus, the AS 104 that automatically generates the complex queries may be configured to search for related keywords within the context of the food service domain. For example, if the keyword is “Italian,” the related keywords may include pasta, spaghetti, Fiat, Alfa Romeo, soccer, and the like. However, the AS 104 may automatically select pasta and spaghetti based on the domain of the food service industry.

In another embodiment, the corporate entity 122 may be part of a transportation domain. As a result, if the keyword is “Italian,” the related keywords may include pasta, spaghetti, Fiat, Alfa Romeo, soccer, and the like. However, the AS 104 may automatically select Fiat and Alfa Romeo based on the domain of the transportation domain.

In one embodiment, once the user selects the create query button 208, the complex query may be created and formatted into a search format that is compatible with the social media service 108, 110 and/or 112 selected by the user. For example, some social media services may use a Datasift format, a proprietary format, and the like.

In one embodiment, before the complex query is applied to the social media service, the constant stream of data received from the social media service may need to be pre processed. For example, the AS 104 may receive a the constant stream of data and convert slang terms, abbreviations, hashtags, emoticons and ASCII images into language words (e.g., words in English, or any other language that is used) that can be matched by the keywords and related keywords in the complex query.

In one embodiment, after the complex query is applied to one or more of the social media services 108, 110 and 112, the results may be displayed to the user of the endpoint device 120. In one embodiment, the user may have the opportunity to manually tune the complex query based on a review of the results. For example, certain related keywords that result in a match that is not related to what the user is looking for may be removed. Alternatively, if the user was expecting certain types of results that were not found, the user may tune the complex query by adding one or more related keywords.

In another embodiment, the complex query may be automatically filtered by the AS 104 without user interaction. For example, once the user submits the create query button 208, the AS 104 may automatically create and tune the query over time or after each iteration. For example, the AS 104 may tune the query based on one or more thresholds. For example, a threshold may be 0 and one or more related keywords that result in matches equal to 0 may be removed. In another example, the threshold may be 10 and one or more related keywords that result in matches less than 10 may be removed as being ineffective related keywords.

In addition, the AS 104 may remove related keywords that return a number of matches over a predefined threshold (e.g., 100, 5,000, 20,000, and the like). For example, the related keyword may be too generic or may not be specific enough, which may result in too many matches that include matches that are not relevant. Alternatively, the AS 104 may add related keywords if the complex query did not return enough results.

In one embodiment, after the complex query is tuned to remove one or more of the related keywords, the complex query may be re-generated and re-applied to one or more of the social media services 108, 110 and 112. In one embodiment, the generating, applying, and tuning may be repeated continuously until the complex query is manually stopped, a desired number of search results is obtained or until a pre-determined period of time is reached.

As a result, the system 100 provides an AS 104 that can automatically generate a complex query based on a single keyword entered by a user. In addition, the system 100 leverages external DBs 114, 116 and 118, a sentiment 204 and a time frame 206 to eliminate false positives and ensure that the complex query finds results that match a context of what the user is looking for within a time frame that that is relevant to the user or the corporate entity 122.

In one embodiment, a complex query may be different from a regular or simple query because the complex query includes additional relevant keywords, a sentiment and a time frame. The complex query is applied to search for matches within the context defined by the related keywords, sentiment, time frame and/or a particular domain.

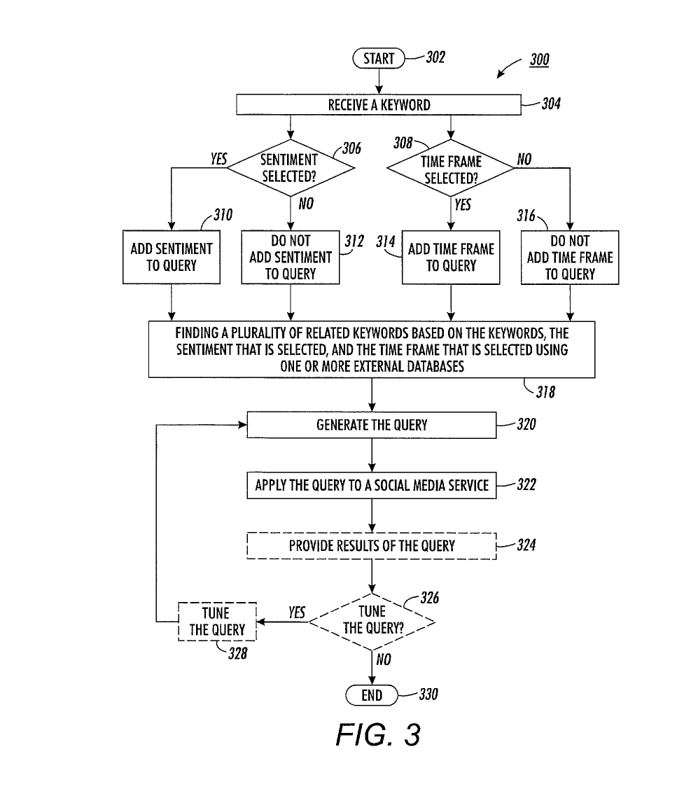

FIG. 3 illustrates a flowchart of a method 300 for developing a query on a social media service. In one embodiment, one or more steps or operations of the method 300 may be performed by the endpoint device 120, the AS 104 or a computer as illustrated in FIG. 4 and discussed below.

At step 302 the method 300 begins. At step 304, the method 300 receives a keyword. In one embodiment, a user may enter a single keyword in a GUI or webpage of the complex query generating service provider via an endpoint device. In one embodiment, the keyword may be within a context of a specific domain that is associated with a corporate entity of the user. For example, an AS may be configured to generate complex queries and apply the complex queries for a specific domain. As a result, when the single keyword is expanded automatically, only those related keywords relevant to the specific domain may be added to the complex query.

In one embodiment, the method 300 may then perform step 306 and step 308 in parallel. At step 306, the method 300 may determine if a sentiment is selected. For example, the user may select a sentiment of happy, unhappy or none. If a sentiment is selected (e.g., happy or unhappy), the method 300 may proceed to step 310 to add the sentiment to the query. For example, related sentiment keywords may be found that are associated with the selected sentiment to add to the query. If a sentiment is not selected (e.g., none), the method 300 may proceed to step 312, where no sentiment is added to the query.

At step 308, the method 300 may determine if a time frame is selected. For example, the user may select a time frame of past, present, future or none. If a time frame is selected (e.g., past, present or future), the method 300 may proceed to step 314 to add a time frame to the query. For example, related time frame keywords may be found that are associated with the selected time frame to add to the query. If a time frame is not selected (e.g., none), the method 300 may proceed to step 316, where no time frame is added to the query.

At step 318, the method 300 finds a plurality of related keywords based on the keywords, the sentiment that is selected, and the time frame that is selected using one or more external databases. For example, the one or more external databases may be third party online dictionaries, online thesauruses, online topic databases and the like that can be used to find the one or more related keywords.

At step 320, the method 300 generates the query. For example, a complex query may be generated in a format compatible with the social media service that the complex query will be applied to. Notably, each social media service may use different query formats, such as a Datasift format, SPARQL Protocol and RDF Query Language (SPARQL) format, JavaScript Object Notation (JSON), or other formats for a particular social media service.

At step 322, the method 300 applies the query to a social media service. For example, the complex query may be generated in one or more different formats for a respective one or more different social media services. The complex query may be applied to the social media services to obtain search results.

In one embodiment, before the complex query is applied to the social media service, the constant stream of data received from the social media service may need to be pre processed. For example, slang terms, abbreviations, hashtags, emoticons and ASCII images may need to be converted into language words (e.g., words in English, or any other language that is used) that can be matched by the keywords and related keywords in the complex query.

At optional step 324, the method 300 may provide the results of the query. In one embodiment, the search results may be displayed to the user via the GUI that received the keyword.

At optional step 326, the method 300 may determine whether the query should be tuned. For example, based on the search results, the complex query may need to be tuned to remove or add one or more related keywords due to a lack of search results or too many search results. If the query should be tuned, the method 300 may proceed to step 328.

At optional step 328, the method 300 may tune the query. For example, the query may be tuned manually, automatically or both manually and automatically. In one embodiment, the complex query may be tuned manually by the user. For example, certain related keywords that result in a match that is not related to what the user is looking for may be removed. Alternatively, if the user was expecting certain types of results that were not found, the user may tune the complex query by adding one or more related keywords.

In another embodiment, the complex query may be automatically filtered by the AS without user interaction. For example, once the complex query is generated and applied, the AS may automatically create, apply and tune the query over time. For example, the AS may tune the query based on one or more thresholds. For example, a threshold may be 0 and one or more related keywords that result in matches equal to 0 may be removed. In another example, the threshold may be 10 and one or more related keywords that result in matches less than 10 may be removed as being ineffective related keywords.

In addition, the AS may remove related keywords that return a number of matches over a predefined threshold (e.g., 100, 5,000, 20,000, and the like). For example, the related keyword may be too generic or may not be specific enough, which may result in too many matches that include matches that are not relevant. Alternatively, the AS may add related keywords if the complex query did not return enough results.

In one embodiment, the complex query may be manually and automatically tuned. For example, the user may remove keywords that find results unrelated to what the user is looking for. Then, the complex query may be automatically tuned used the methods described above.

In one embodiment, due to the stream of data from the social media services being continuous and unending, the complex query may be tuned and re-tuned indefinitely as the character of the results change. For example, over time slang may go out of vogue. Thus, the method 300 may remain in the loop between steps 320-326 for a long period of time as data is continuously received from the social media services. However, the user may eventually decide that the results are satisfactory and stop tuning the complex query.

Referring back to the optional step 326, if the query does not need to be tuned, the method 300 may proceed to step 330. At step 330, the method 300 ends.

As a result, the embodiments of the present disclosure transform a single key word into a complex query that considers sentiment and time frame for a particular industry or domain. The data is transformed from providing a generic key word search that could return thousands of irrelevant matches into a complex query that accurately reflects the intention of the query.

Furthermore, the embodiments of the present disclosure improve the functioning of an application server or a computer. For example, more accurate and complex queries may be generated by the computer that could not otherwise be created without the improvements provided by the present disclosure. In other words, the technological art of querying is improved by providing a computer that is modified with the ability to automatically generate complex queries that are specific to a sentiment, a time frame and a particular domain as disclosed by the present disclosure.

It should be noted that although not explicitly specified, one or more steps, functions, or operations of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 3 that recite a determining operation, or involve a decision, do not necessarily require that both branches of the determining operation be practiced. In other words, one of the branches of the determining operation can be deemed as an optional step.

FIG. 4 depicts a high-level block diagram of a computer that can be transformed to into a machine that is dedicated to perform the functions described herein. Notably, no computer or machine currently exists that performs the functions as described herein. As a result, the embodiments of the present disclosure improve the operation and functioning of the computer to develop complex queries, as disclosed herein.

As depicted in FIG. 4, the computer 400 comprises one or more hardware processor elements 402 (e.g., a central processing unit (CPU), a microprocessor, or a multi-core processor), a memory 404, e.g., random access memory (RAM) and/or read only memory (ROM), a module 405 for developing a query on a social media service, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the steps of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 405 for developing a query on a social media service (e.g., a software program comprising computer-executable instructions) can be loaded into memory 404 and executed by hardware processor element 402 to implement the steps, functions or operations as discussed above in connection with the exemplary method 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for developing a query on a social media service (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus for developing a query on a social media service, comprising:
a processor; and
a computer-readable medium storing a plurality of instructions, which when executed by the processor, cause the processor to perform operations, the operations comprising:
receiving a keyword;
providing an option to select a sentiment and an option to include a time frame;
finding a plurality of related keywords based on the keyword, the sentiment that is selected and the time frame that is selected using one or more external databases;
generating the query using the keyword and all of the plurality of related keywords; and
applying the query to the social media service.

2. The apparatus of claim 1, wherein a data set from the social media service is preprocessed to convert slang terms, abbreviations, hashtags, emoticons and ASCII images into language words.

3. The apparatus of claim 1, wherein the sentiment comprises a happy sentiment, an unhappy sentiment or no sentiment.

4. The apparatus of claim 1, wherein the time frame comprises a past, a future, a present or no time frame.

5. The apparatus of claim 1, wherein the generating comprises formatting the query into a format that is compatible with the social media service.

6. The apparatus of claim 1, further comprising:
providing results of the query;
tuning the query based on the results; and
re-applying the query that is tuned to the social media service.

7. The apparatus of claim 6, wherein the tuning comprises a manual tuning or an automatic tuning.

8. The apparatus of claim 7, wherein the manual tuning comprises removing from the query one or more related keywords of the plurality of related keywords or adding one or more additional related keywords selected by a user.

9. The apparatus of claim 7, wherein the automatic tuning comprises removing from the query one or more related keywords that provide a number of search results above a first threshold and below or equal to a second threshold.

10. The apparatus of claim 1, wherein the apparatus is configured for a specific domain.

11. A method for developing a query on a social media service, comprising:
receiving, by a processor, a keyword;
providing, by the processor, an option to select a sentiment and an option to include a time frame;
finding, by the processor, a plurality of related keywords based on the keyword, the sentiment that is selected and the time frame that is selected using one or more external databases;
generating, by the processor, the query using the keyword and all of the plurality of related keywords; and
applying, by the processor, the query to the social media service.

12. The method of claim 11, wherein a data set from the social media service is preprocessed to convert slang terms, abbreviations, hashtags, emoticons and ASCII images into language words.

13. The method of claim 11, wherein the sentiment comprises a happy sentiment, an unhappy sentiment or no sentiment.

14. The method of claim 11, wherein the time frame comprises a past, a future, a present or no time frame.

15. The method of claim 11, wherein the generating comprises formatting the query into a format that is compatible with the social media service.

16. The method of claim 11, further comprising:
providing results of the query;
tuning the query based on the results; and
re-applying the query that is tuned to the social media service.

17. The method of claim 16, wherein the tuning comprises a manual tuning or an automatic tuning.

18. The method of claim 17, wherein the manual tuning comprises removing from the query one or more related keywords of the plurality of related keywords or adding one or more additional related keywords selected by a user.

19. The method of claim 17, wherein the automatic tuning comprises removing from the query one or more related keywords that provide a number of search results above a first threshold and below or equal to a second threshold.

20. A method for developing a query on a social media service, comprising:
receiving, by a processor, a constant stream of data from the social media service;
preprocessing, by the processor, the constant stream of data to convert slang terms, abbreviations, hashtags, emoticons and ASCII images into language words;
receiving, by the processor, a keyword;
establishing, by the processor, a communication session with a third party language website;
finding, by the processor, a plurality of related keywords based on the keyword using a third party language website;
providing, by the processor, an option to select a sentiment and an option to include a time frame;
receiving, by the processor, a sentiment;
finding, by the processor, a plurality of sentiment keywords based on the sentiment using the third party language website;
receiving, by the processor, a time frame;
finding, by the processor, a plurality of time frame keywords based on the time frame;
generating, by the processor, the query using the keyword, all of the plurality of related keywords, the plurality of sentiment keywords and the plurality of time frame key words within a specific domain in a format that is compatible with the social media service;
applying, by the processor, the query to the social media service;
tuning, by the processor, the query based on results of the query that is applied to the social media service;
storing, by the processor, the results; and
repeating, by the processor, the generating, the applying, the tuning and the storing on the constant stream of data from the social media service continuously.
